(19) United States
(12) Patent Application Publication
(10) Pub. No.: US 2022/0335661 A1
(43) Pub. Date: Oct. 20, 2022

(54) SYSTEM AND METHOD FOR PLAYBACK OF AUGMENTED REALITY CONTENT TRIGGERED BY IMAGE RECOGNITION

(71) Applicant: Google LLC, Mountain View, CA (US)

(72) Inventors: Max Spear, San Francisco, CA (US); Nicholas Solochin, Santa Clara, CA (US); Anish Dhesikan, Brooklyn, NY (US); Kai Yu, San Francisco, CA (US); Jacob Hanshaw, San Francisco, CA (US); Yue Li, Santa Clara, CA (US); Charles DiFazio, Mountain View, CA (US)

(21) Appl. No.: 17/753,425

(22) PCT Filed: Feb. 28, 2020
(86) PCT No.: PCT/US2020/020319

§ 371 Date: Mar. 2, 2022

(51) Int. Cl. G06T 11/00; G06V 20/20

(52) U.S. Cl. CPC G06T 11/00; G06V 20/20; G06T 2200/24

(57) ABSTRACT

Systems and methods for accessing augmented reality (AR) content, including dynamic AR content, relatively quickly, and relatively easily, are provided. An enabled target entity may be identified within a camera view of a mobile computing device, and a server computing device may identify the target entity, match the target entity with dynamic AR content, and transmit the dynamic AR content to the client computing device. This may allow users to consume content-rich information and/or to experience real time interaction with the images and objects in their surroundings, that would otherwise be difficult and/or unrealistic to condense into physical media, and/or that would be otherwise difficult and/or unrealistic to provide in a real time, interactive experience.

### FIELD

This relates to the display of image content, and in particular to the playback of augmented reality video content.

### BACKGROUND

Users of mobile computing devices, such as, for example, smartphones, tablet computing devices and the like, may like to use their mobile computing devices to learn more about objects, entities and the like in the environment in which the user, and the computing device is operating. Mobile computing devices often include image sensors, or cameras. These cameras may capture images of entities in the environment in which the computing device operates. Availability of content, or experiences, that relate to those entities via the mobile computing device, may improve the user experience, and may enhance functionality and utility of the mobile computing device to the user.

### SUMMARY

In one general aspect, a computer-implemented method may include capturing an image within a live viewfinder of a client computing device, transmitting, by the client computing device, a query to a server computing device, the query including the image, receiving, by the client computing device, a response to the query from the server computing device, the response including augmented reality content, and triggering display of a user interface screen on the client computing device, the user interface screen including the augmented reality content displayed within a contour defined by coordinates included in the response received from the server computing device.

In some implementations, the image may include a target entity captured within a field of view of the live viewfinder of the client computing device. In some implementations, receiving the response to the query may include receiving augmented reality video content associated with the target entity included in the image. In some implementations, receiving the response to the query from the server computing device may include receiving the coordinates defining the contour for the display of the augmented reality video content on the user interface screen, the contour corresponding to a periphery of the target entity.

In some implementations, triggering display of the user interface screen may include displaying the user interface screen within the live viewfinder of the client computing device, and attaching the display of the augmented reality video content to the target entity at attachment points corresponding to the coordinates, such that the display of the augmented reality video content remains attached to the target entity within the live viewfinder of the client computing device.

In some implementations, the computer-implemented method may also include detecting a first movement of the client computing device, shifting a display of the target entity within the live viewfinder of the client computing device in response to the detected first movement, and shifting a display of the augmented reality video content to correspond to the shifted display position of the target entity within the live viewfinder of the client computing device. In some implementations, detecting the first movement may include detecting at least one of a change in a position, an orientation, or a distance between the live viewfinder of the client computing device and the target entity, and shifting the display of the augmented reality video content may include changing at least one of a display position, a display orientation, or a display size of the augmented reality video content to respectively correspond to the changed display position, orientation or distance of the target entity. In some implementations, the computer-implemented method may also include detecting a second movement of the client computing device such that the target entity is not captured within the live viewfinder of the client computing device, and terminating the display of the augmented reality video content in response to the detected second movement. In some implementations, triggering display of the user interface screen may include looping the augmented reality content until the second movement is detected, or until a termination input is received.

In some implementations, triggering display of the user interface screen may include triggering display of a display panel and a user input panel, and receiving the response to the query may include receiving the augmented reality video content for display on the display panel of the user interface screen, and receiving auxiliary information related to the target entity for display on the user input panel of the user interface screen.

In some implementations, the capturing the image within the live viewfinder of a client computing device, the transmitting, the receiving, and the triggering are done within an application running on the client computing device.

In another general aspect, a computer-implemented method may include receiving, by a server computing device, a query from a client computing device, the query including an image, detecting, by a recognition engine of the server computing device, a target entity within the image included in the query, matching, in an indexed database of the server computing device, the target entity with augmented reality content from an external provider, and transmitting, to the client computing device, the augmented reality content for output by the client computing device.

In some implementations, receiving the query including the image may include receiving the query including the image in which the target entity is captured within a live viewfinder of the client computing device. In some implementations, detecting the target entity within the image included in the query may include identifying the target entity based on a target image linked with the recognition engine by the external provider. In some implementations, matching the target entity with the augmented reality content may include matching the target entity with content, linked in the indexed database with the target image by the external provider. In some implementations, detecting the target entity may include detecting a peripheral contour of the target entity within the image, and defining attachment points along the detected peripheral contour so as to define the peripheral contour of the target entity. In some implementations, transmitting the augmented reality content for output by the client computing device may include transmitting the attachment points to the client computing device together with the augmented reality content, for output of the augmented reality content by the client computing device within the contour defined by the attachment points.

In another general aspect, a computer-readable storage medium may store instructions which, when executed by one or more processors, may cause the one or more processors to perform the computer-implemented method described above.

In another general aspect, a client computing device, may include a live viewfinder, one or more processors, and a memory storing instructions which, when executed by the one or more processors, may cause the one or more processors to perform the computer-implemented method described above.

In another general aspect server computing device may include a recognition engine, an indexed database, one or more processors, and a memory storing instructions which, when executed by the one or more processors, cause the one or more processors to perform the computer-implemented method described above.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an exemplary system, in accordance with implementations described herein.

FIGS. 2A and 2B are third person views of an exemplary physical space in which an implementation of an exemplary client computing device of the exemplary system shown in FIG. 1 is operable, in accordance with implementations described herein.

FIGS. 3A through 3H illustrate a sequence of exemplary user interface screens of the exemplary client computing device 102 shown in FIGS. 2A and 2B, for displaying exemplary augmented reality content associated with a detected target entity, in accordance with implementations described herein.

FIGS. 4A through 4J illustrate a sequence of exemplary user interface screens of the exemplary client computing device 102 shown in FIGS. 2A and 2B, for displaying exemplary augmented reality content and auxiliary information associated with a detected target entity, in accordance with implementations described herein.

FIG. 5 is a flowchart of an exemplary method of accessing and displaying augmented reality content associated with a target entity, in accordance with implementations described herein.

FIG. 6 is a flowchart of an exemplary method of processing a visual-content query to provide exemplary augmented reality content and auxiliary information associated with a detected target entity, in accordance with implementations described herein.

FIGS. 7A-7D illustrate the identification of a target image within various materials, in accordance with implementations described herein.

FIGS. 8A-8F illustrate a sequence of exemplary user interface screens of the exemplary client computing device 102 shown in FIGS. 2A and 2B, for displaying exemplary augmented reality content, in accordance with implementations described herein.

FIG. 9 is a flowchart of an exemplary method of linking a target image and augmented reality content to an exemplary server computing device, in accordance with implementations described herein.

FIG. 10 is a schematic diagram of an exemplary computing device and a mobile computing device that can be used to implement the techniques described herein.

Reference will now be made in detail to non-limiting examples of this disclosure, examples of which are illustrated in the accompanying drawings. The examples are described below by referring to the drawings, wherein like reference numerals refer to like elements. When like reference numerals are shown, corresponding description(s) are not repeated and the interested reader is referred to the previously discussed figure(s) for a description of the like element(s).

### DETAILED DESCRIPTION

A system and method, in accordance with implementations described herein, may allow a user to access and experience augmented reality (AR) content, including dynamic AR content, relatively quickly, and relatively easily, in response to identification of an enabled entity in a camera view of a mobile computing device. A system and method, in accordance with implementations, may allow a provider to attach AR content, including dynamic AR content, to identifiable, enabled entities, in a relatively simple manner. In particular, the present disclosure describes technological improvements that simplify the identification and presentation of AR content, including dynamic AR content, based on visual content captured and/or identified within a camera view of a mobile computing device. In some implementations, a system and method described herein may generate an index of AR content, including dynamic AR content, that is relevant to the enabled entity identified in the camera view of the mobile computing device. In some implementations, this index of AR content may allow a user to access AR content through a single application running on the mobile computing device via network-accessible resources (e.g., web pages) disposed throughout the world. Thus, a system and method, in accordance with implementations described herein, may allow users to use a mobile computing device to learn more about physical images and objects as they are encountered, using a single application, rather than multiple, separately downloaded applications specific to the images, objects and the like that are encountered. This may allow users to consume content-rich information and/or to experience real time interaction with the images and objects in their surroundings, that would otherwise be difficult and/or unrealistic to condense into physical media, and/or that would be otherwise difficult and/or unrealistic to provide in a real time, interactive experience.

For example, in some implementations, a client computing device, such, for example, a smartphone, a tablet computing device and the like, may capture an image of an entity, for example, within a field of view, or a viewfinder, of an image sensor, or a camera, of the client computing device. The client computing device may transmit a query, for example, a visual-content query, based on the image to a server computing device. In response to receiving the query, the server computing device may match the image in the query to an indexed database.

In a system and method, in accordance with implementations described herein, the matching of an image to content in an indexed database is completed by the server computing device, rather than the client computing device. In this situation, server side image recognition may be performed by the server computing device for the identification, or recognition of the image included in the query (received from the client computing device), and the subsequent matching of the recognized/identified image with the indexed content held in the indexed database. For example, in some implementations, data from the image that may be used by the server computing device in recognizing and/or identifying the target entity may include text that is extracted from the image using, for example, optical character recognition, values read from barcodes, QR codes, etc., in the image, identifiers or descriptions of entities, products, or entity types identified in the image, and other such information. In this situation, this type of server side image recognition may provide advantages over client side image recognition which could instead be performed locally by the client computing device via, for example, an application running locally on the client computing device. For example, a number of images which could realistically be embedded within an application running on the client computing device would be naturally limited by the amount of storage space available, computational power available to index and process the images, and the like. Similarly, client side image recognition may, in some circumstances, rely on the use of numerous different applications, operating separately on the client computing device, depending on the entity captured in the image (for example, a particular type of subject matter, a particular venue, and the like). In contrast, server side image recognition may provide access to a considerably larger number of indexed images, for example, a theoretically limitless number of indexed images accessible by the server computing device, through a single application, regardless of the entity captured in the image.

Based on the matching, or identification, of the image with the indexed database, the server computing device may transmit content, for example, augmented reality content, to the client computing device. For example, in some implementations, the augmented reality content may be provided by a network-accessible resource, such as, for example, a web page that is indexed, or associated with, the recognized/identified target entity. In some implementations, the augmented reality content may include moving image content, or video content, to be displayed on a display of the client computing device. The augmented reality content transmitted from the server computing device to the client computing device may be based on the recognition and/or identification of the entity captured in the image and matched to the indexed database, such that the content is germane and/or specifically associated with the entity captured in the image.

For example, in a situation involving client-side image recognition, or client-side image detection, images would be downloaded to the client computing device 102 beforehand, thus creating a natural maximum on the number of images realistically available to use in the identification/recognition process (driven by, for example, available storage capacity of the client computing device 102 and other such factors). Performing server-side image recognition (i.e., by the server computing device 170) rather than client-side image recognition (i.e., by the client computing device 102) provides for much more precise image recognition and the ability to distinguish between images that look similar, since the index of images is of a much larger scale than what is realistically possible on the client computing device 102 (i.e., measured in billions). In some implementations, storing and maintaining this vast index of images on the server computing device 170 (rather than locally, on the client computing device 102) may allow the index of images to be updated relatively quickly, and dynamically, without frequently affecting the network, storage and the like of the client computing device 102 due to synching. Completing this task server-side may allow image recognition to be done accurately, with relatively little cross-triggering, and at relatively low latency. Further, in completing this task server-side, the server computing device 170 can identify the target entity within the image, identify corresponding coordinates, and transmit that information to the client computing device 102, so that only the target entity identified by the coordinates is tracked (for example, rather than the entire image), thus reducing resources consumed.

In some implementations, in processing the query (transmitted from the client computing device to the server computing device), the server computing device may detect the confines, or the peripheral contour, or the periphery, of the target entity captured in the image as part of the recognition/identification process. For example, in some situations, the target entity may have a substantially square, or substantially rectangular, periphery or peripheral contour. In this exemplary implementation, the transmission of the augmented reality content, for example, video content, from the server computing device to the client computing device may include coordinates defining the quadrangle associated with the target entity within the image. Thus, as the video content plays, for example, on the live viewfinder of the client computing device, together with the target entity captured within the viewfinder, the video content may appear to be attached to the target entity as the video content plays within the live viewfinder of the client computing device. That is, as the user shifts a position of the client computing device, the position of the target entity within the live viewfinder may shift accordingly, and a display position of the augmented reality video content may shift together with the target entity. In this manner, the target entity may appear to come to life as the video content plays, thus enhancing the user's experience of the augmented reality content.

In some implementations, the video content may remain attached to the target entity, within the viewfinder of the client computing device, even as the user moves and/or changes the position and/or orientation of the client computing device, to further enhance the realistic appearance of the augmented reality content. In some implementations, in response to detection of movement of the client computing device such that the target entity is no longer captured within the field of view of the client computing device and/or visible on the viewfinder of the client computing device, playback of the video content may be terminated. In some implementations, the video content may continue to play, or loop, until the target entity is no longer captured within the field of view of the client computing device and/or visible on the viewfinder of the client computing device, and/or until otherwise terminated by the user. In some implementations, the augmented reality content provided to the client computing device from the server computing device may provide the user with access to additional information related to the target entity.

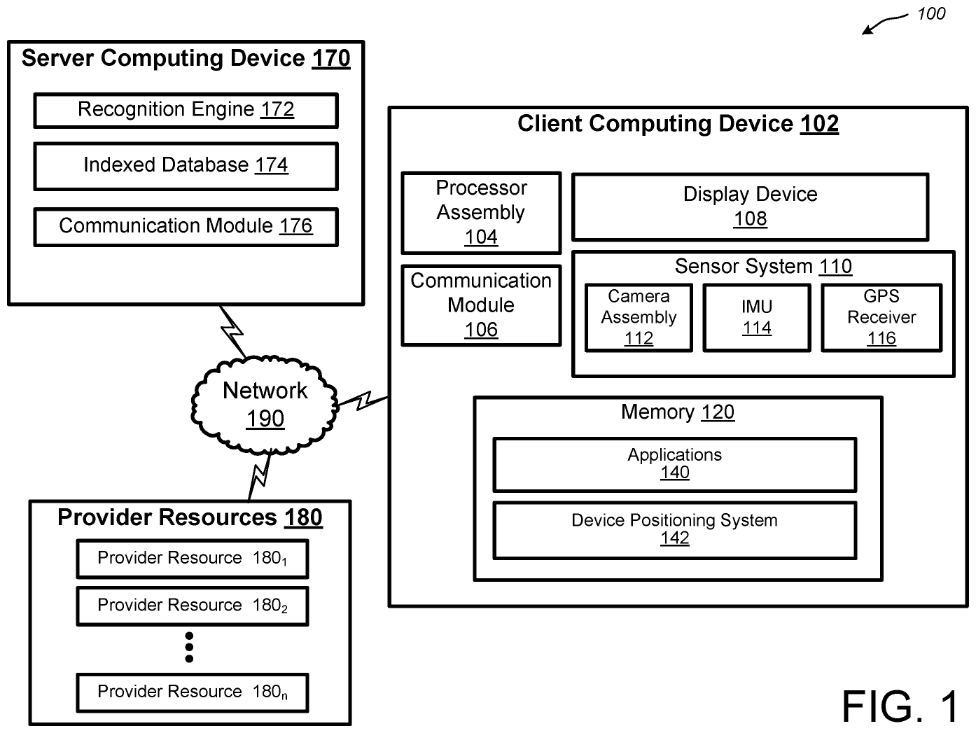

FIG. 1 is a block diagram of a system 100 for playback of augmented reality content, in accordance with implementations described herein. In some implementations, the system 100 may include a client computing device 102, a server computing device 170 (e.g., a search server), and provider resources 180 (e.g., one or more digital supplement servers). Also shown is a network 190 over which the client computing device 102, the server computing device 170, and the provider resources 180 may communicate.

In some implementations, the system 100 may include a client computing device 102 including a processor assembly 104, a communication module 106, a display device 108, a sensor system 110, and a memory 120. In some implementations, the memory 120 may include one or more non-transitory computer-readable storage media. The memory 120 may store instructions and data that are usable by the client computing device 102 to implement the technologies described herein. In some implementations, the processor assembly 104 may include one or more devices that are capable of executing instructions, such as instructions stored by the memory 120. For example, in some implementations, the processor assembly 104 may include a central processing unit (CPU) and/or a graphics processor unit (GPU). In some implementations, the sensor system 110 may include various sensors, such as, for example, a camera assembly 112, an inertial measurement unit (IMU) 114, a global positioning system (GPS) receiver 116, and other sensors, including, for example, a light sensor, an audio sensor, an image sensor, a distance and/or proximity sensor, a contact sensor such as a capacitive sensor, a timer, and/or other sensors and/or different combinations of sensors. In some implementations, the client computing device 102 is a mobile device (e.g., a smartphone, a tablet computing device and the like).

The camera assembly 112 may capture images of the physical space proximate the client computing device 102, including, for example, a target entity visible within the field of view, or within a viewfinder, of the camera assembly 112.In some implementations, images captured by the camera assembly 112 may be used to determine a location and/or an orientation of the client computing device 102 within a physical space, and/or relative to a target entity and the like.

In some implementations, the IMU 114 may detect motion, movement, and/or acceleration of the client computing device. The IMU 114 may include various different types of sensors such as, for example, an accelerometer, a gyroscope, a magnetometer, and other such sensors. An orientation of the client computing device 102 may be detected and tracked based on data provided by the IMU 114 and/or by the GPS receiver 116.

In some implementations, the memory 120 may include one or more applications 140 available for execution on the client computing device 102. In some implementations, a device positioning system 142 may determine a position of the client computing device 102 based on, for example, data provided by the sensor system 110.

In some implementations, the client computing device 102 may communicate with the server computing device 170 over the network 190 (via, for example, the communication module 106 of the client computing device 102 and a communication module 176 of the server computing device 170). For example, the client computing device 102 may send an image, captured by the camera assembly 112, to the server computing device 170. The server computing device 170 may identify target entities within the image using, for example, a recognition engine 172, and may access an indexed database 174 to identify content, for example, augmented reality content, associated with the target entity. In some implementations, the indexing of the identified target entity with the associated augmented reality content in the indexed database 174 may point to content provided by network-accessible resources 180, such as, for example, provider websites 180 or provider webpages 180. Numerous provider resources 180 (i.e., provider resources 1801 through 180n) may communicate via the network 190 with the server computing device 170 and/or the client computing device 102. Content, for example, augmented reality content (including, for example, augmented reality video content), associated with the target entity, may be accessed via the provider webpage 180, for display on the display device 108 of the client computing device 102.

In some implementations, the client computing device 102 may be embodied in the form of a mobile computing device such as a smartphone, a tablet computing device, a handheld controller, a laptop computing device, and the like. In some implementations, the client computing device 102 may be embodied in the form of a wearable device such as, for example, a head mounted display device (HMD). In some implementations, the HMD may be a separate device from the client computing device 102. In some implementations, the client computing device 102 may communication with the HMD. For example, in some implementations, the client computing device 102 may transmit video signals and/or audio signals to the HMD for output to the user, and the HMD may transmit motion, position, and/or orientation information to the client computing device 102.

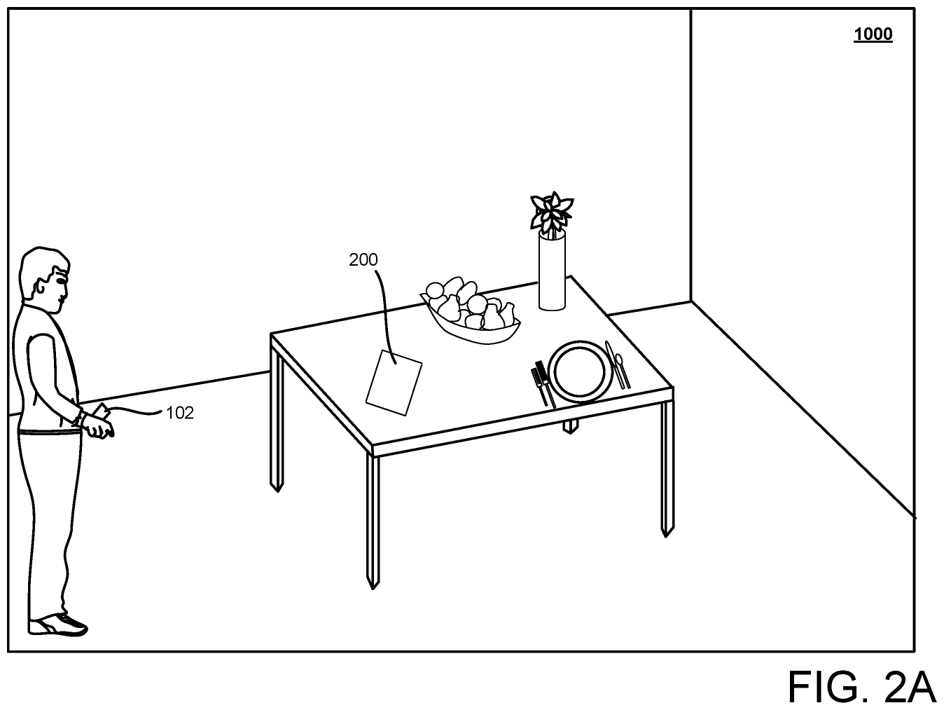

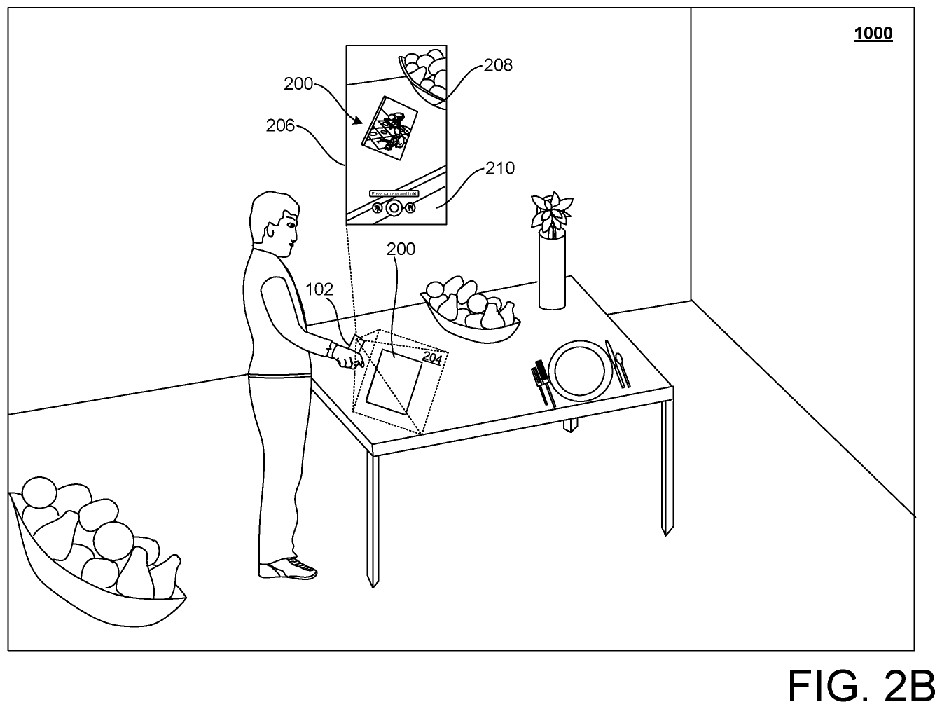

FIGS. 2A and 2B are third person views of a user in an exemplary physical environment 1000, encountering an exemplary target entity 200, or an exemplary target image 200. In the example shown in FIGS. 2A and 2B, the exemplary target entity 200 is a substantially planar target entity 200, or target image 200. In the example shown in FIGS. 2A and 2B, the exemplary client computing device 102 is a handheld device 102, simply for ease of discussion and illustration, and the principles to be described herein may be applied to other types of client computing devices as set forth above.

As the user approaches the exemplary target entity 200, the target entity 200 is within a field of view 204 of the camera assembly 112 of the client computing device 102. The exemplary target entity 200 (in the form of a magazine in this example) is captured in the viewfinder of the camera assembly 112, and is visible to the user via an exemplary user interface screen 206, as shown in FIG. 2B. For example, the user interface screen 206 may be displayed on the display device 108 of the client computing device 102. In some implementations, the user interface screen 206 may include an image display panel 208. In some implementations, the user interface screen 206 may also include a user input panel 210. In some implementations, the user input panel 210 may provide for user interaction with content displayed in the image display panel 208. In the example illustrated in FIG. 2B, the image display panel 208 shows an image corresponding to a real-time feed from the camera assembly 112 of the client computing device 102.

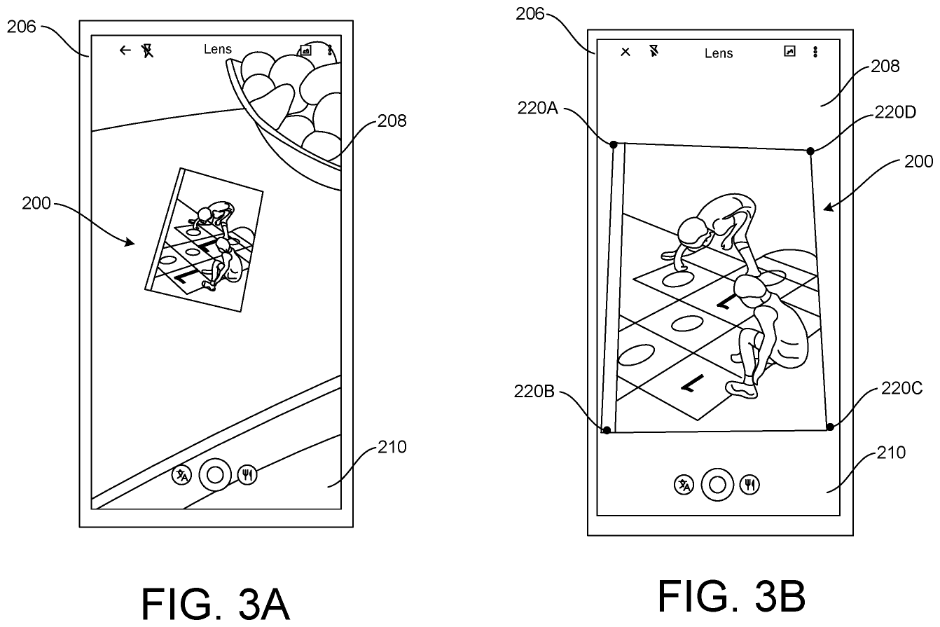

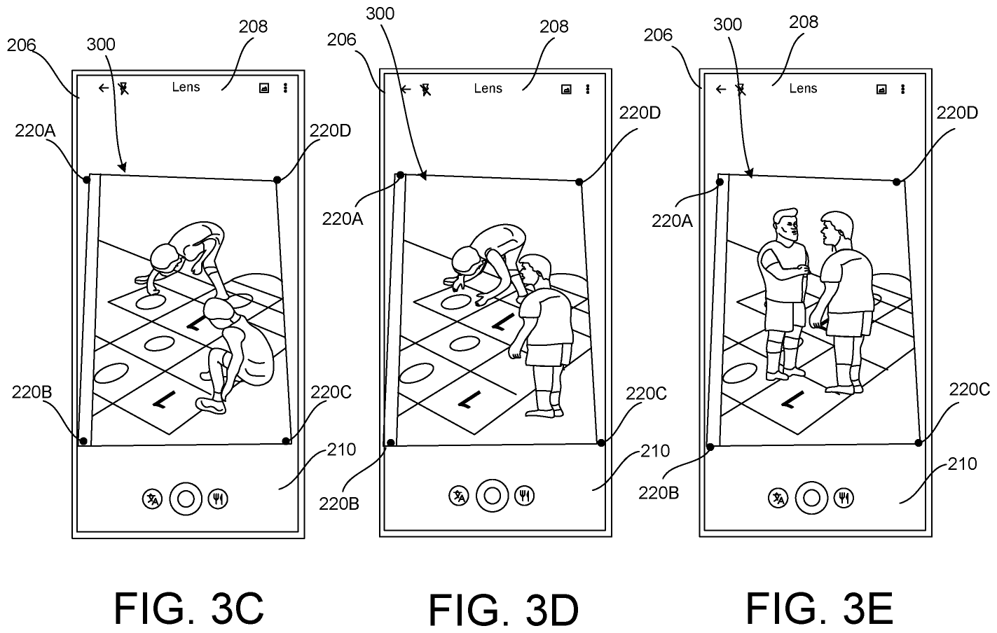

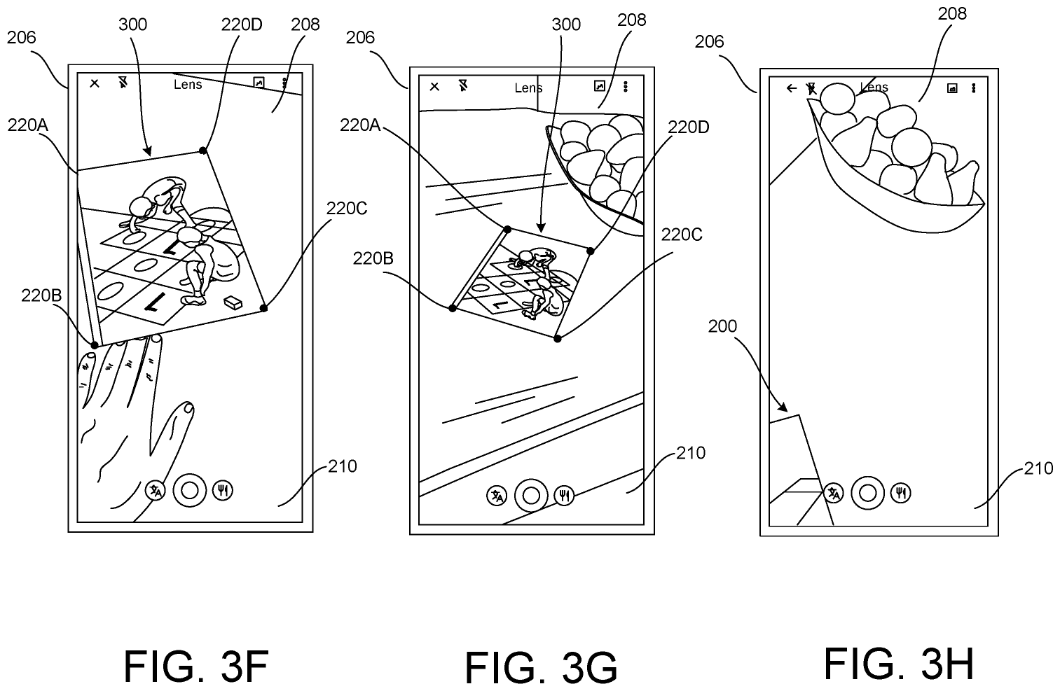

FIGS. 3A-3H illustrate a sequence of exemplary user interface screens that may be displayed by the client computing device 102 in detecting a target entity, or target image, in conducting a visual-content search based on the target entity, and in displaying augmented reality content, for example, augmented reality video content, associated with the detected target entity, in accordance with implementations described herein. In some implementations, the exemplary sequence of user interface screens shown in FIGS. 3A-3H, and the exemplary display of augmented reality content, for example, augmented reality video content, may be displayed within an application running on the client computing device 102.

As described with respect to FIGS. 2A and 2B, when the target entity 200 is within the field of view 204 of the camera assembly 112 of the client computing device 102, the target entity 200 may be visible to the user via the display panel 208 of the user interface screen 206, as shown in FIGS. 3A and 3B. The client computing device 102 may transmit an image frame, such as, for example, the image displayed on the display panel 208 shown in FIG. 3B, to the server computing device 170. In response to receiving the image frame from the client computing device 102 (from, for example, the application running on the client computing device 102), the recognition engine 172 of the server computing device 170 may recognize, or identify, the target entity 200. The server computing device 170 may then match the identified target entity 200 with associated content in the indexed database 174. In some implementations, the matching of associated content with the target entity 200 may direct the server computing device 170 to the provider resource 180 for access to the associated content. The associated content, for example, augmented reality content, and in particular, augmented reality video content, may then be transmitted to the client computing device 102, for display on the display panel 208 of the user interface.

As described above, in some implementations, in identifying the target entity 200, the recognition engine 172 of the server computing device 170 may analyze data from the image including, for example, text extracted from the image, values read from barcodes, QR codes and the like, identifiers or descriptions, products, and other entity and information, against information stored in the indexed database.

In some implementations, in analyzing the image and identifying the target entity 200, the server computing device 170 may recognize, or identify, the boundaries, or periphery, or contour, or shape, of the target entity 200. For example, in the exemplary implementation illustrated in FIGS. 2A-3H, the target entity 200 has a substantially rectangular periphery, simply for purposes of discussion and illustration. In this example, the transmission, or streaming, of augmented reality video content to the client computing device 102 may include a definition of one or more attachment points for the display of the augmented reality content.

In the example shown in FIG. 3B, the target entity 200 is substantially planar and is defined by a substantially rectangular outer periphery, or contour. Thus, in this example, the server computing device 170 may identify, or detect, or define, the confines of the target entity 200 by the four exemplary points 220 or attachment points 220 (220A, 220B, 220C and 220D) shown in FIG. 3B. In some implementations, the augmented reality content may be transmitted to, or streamed to, the client computing device 102 together with the attachment points 220. This may allow the augmented reality content to be displayed on, or played on, the display panel 208 of the user interface screen 206, with the augmented reality content, for example, augmented reality video content, remaining connected to the target entity 200 at the attachment points 220. In general, e.g., the client computing device 102 is adapted to trigger display of augmented reality content displayed within a contour defined by coordinates included in a response received from the server computing device 170 by means of the user interface screen 206. The coordinates may be, e.g., the attachment points 220. In some implementations, this may allow the augmented reality content to remain connected to the target entity 200, even as the user moves the client computing device 102, as long as the target entity 200 remains in the field of view, or within the viewfinder, of the camera assembly 112 of the client computing device 102. In this manner, the augmented reality content may remain within the frame of the target entity 200, and move together with the target entity, thus appearing to animate the target entity 200, or generating the impression that the target entity 200 has come to life. In some implementations, if the client computing device 102 is moved such that the target entity 200 is no longer captured within the field of view, or within the viewfinder, of the camera assembly of the client computing device 102, the augmented reality experience may be terminated.

For example, returning to FIGS. 3A-3H, augmented reality content 300, for example, augmented reality video content 300, may be transmitted to the client computing device 102, together with the attachments points 220 as described above. The augmented reality content 300 may play, within the confines, or frame, of the target entity 220 defined by the attachment points 220, as shown in FIGS. 3C-3E, while the target entity 200 remains within the field of view, or viewfinder, of the camera assembly 112 of the client computing device 102. In particular, FIGS. 3D-3G illustrate the augmented reality video content 300, playing within the confines, or frame, of the target entity 200, as the relative positions, orientations, distances apart, and the like between the camera assembly 112 of the client computing device 102 and the target entity 200 changes. As shown in FIG. 3H, when the target entity 200 is no longer captured within the field of view, or the viewfinder, of the camera assembly 112 of the client computing device 102, the augmented reality experience is terminated, and real world elements captured within the field of view of the camera assembly 112 of the client computing device 102 are visible on the display panel 208, as shown in FIG. 3H. That is, the augmented reality content 300 no longer plays when the target entity 200 is no longer captured within the field of view, or the viewfinder, of the camera assembly 112 of the client computing device 102, as shown in FIG. 3H.

In the exemplary implementation shown in FIGS. 3A-3H, the user interface screen 206 includes the user input panel 210, displayed together with the display panel 208, for purposes of discussion and illustration. In some implementations, the user interface screen 206 may include both the display panel 208 and the user input panel 210 arranged differently than the exemplary arrangement shown in FIGs, 3A-3H. In some implementations, the user interface screen 206 may include only the display panel 208. In some implementations, other types of annotations, or supplemental information, may be displayed on the display panel 208.

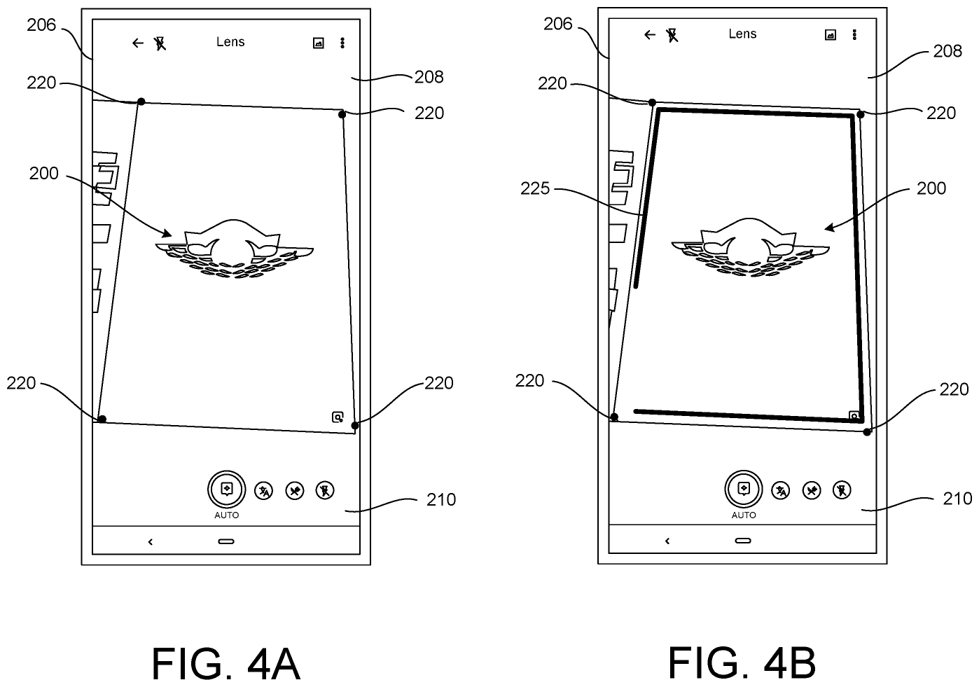

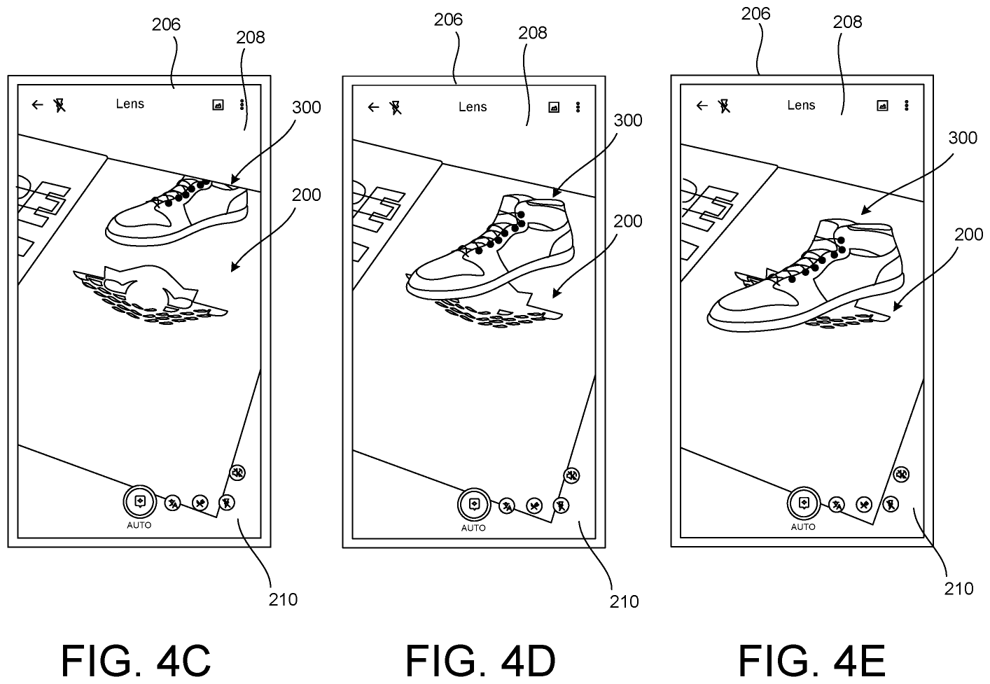

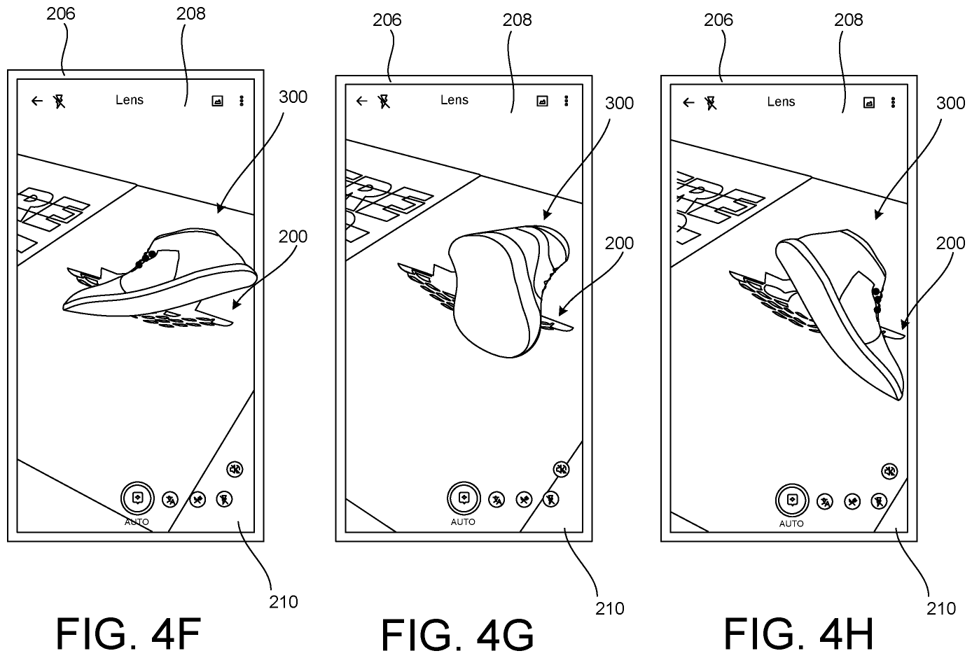

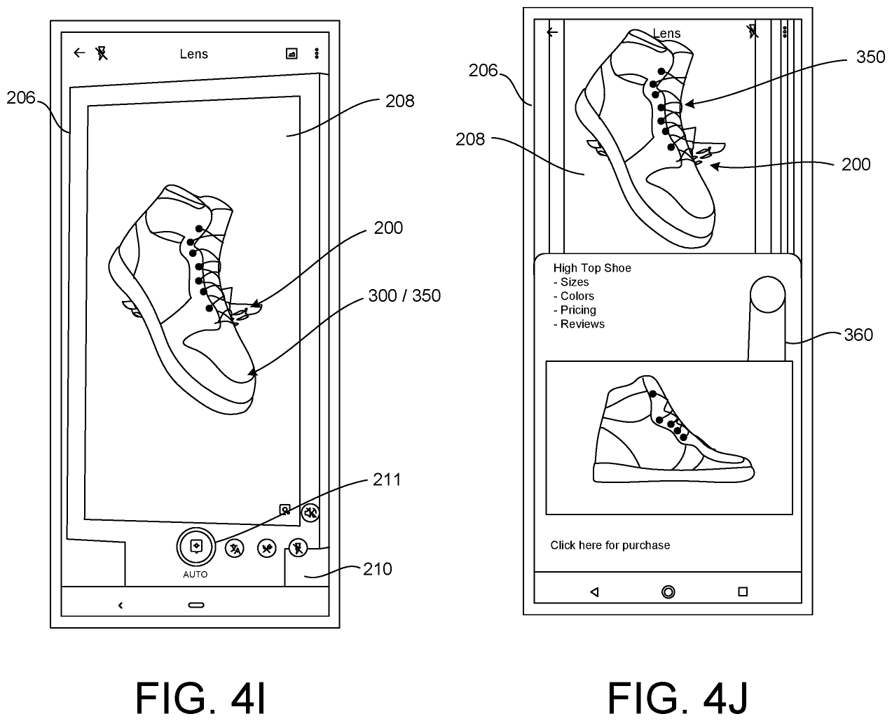

FIGS. 3A-3H and the accompanying description thereof present an exemplary implementation in which augmented reality video content 300 is applied to a cover of a periodical (the target entity 200, in this example), such that the cover of the periodical appears to animate, or come to life. Animation of the cover of the periodical in this manner may, for example, draw the user's attention to information, features and the like included in the periodical and/or the featured cover story, thus engaging the user in experiencing the periodical, piquing the user's interest, encouraging the user to further explore, and the like. FIGS. 4A-4J present a different exemplary implementation, in which augmented reality content may be applied to a target entity, to engage, or immerse, a user in, for example, a shopping experience, in which the user may engage with the augmented reality content (playing on the target entity in the real world space) to take deeper action in the screen-space, or virtual space, related to the target entity, to access additional information related to the target entity, and the like.

FIGS. 4A-4J illustrate a sequence of exemplary user interface screens 206 that may be displayed by the client computing device 102 in detecting a target entity 200, or target image 200, in conducting a visual-content search based on the target entity, and in displaying augmented reality content, for example, augmented reality video content, associated with the detected target entity, in accordance with implementations described herein. In some implementations, the exemplary sequence of user interface screens 206 shown in FIGS. 4A-4J, and the exemplary display of augmented reality content, may be displayed within an application running on the client computing device 102.

Within the application running on the client computing device 102, the exemplary user interface screen 206 shown in FIG. 4A may be displayed by the client computing device 102, representing real-world objects captured within the field of view, or viewfinder, of the camera assembly 112 of the client computing device 102. In this camera view, the target entity 200 is within the field of view 204 of the camera assembly 112 of the client computing device 102, and thus the target entity 200 is visible to the user via the display panel 208 of the user interface screen 206. The client computing device 102 may transmit an image frame corresponding to the image displayed on the display panel 208 shown in FIG. 4A, to the server computing device 170. In response to receiving the image frame from the client computing device 102, the recognition engine 172 of the server computing device 170 may recognize, or identify, the target entity 200, and may match the identified target entity 200 with associated content in the indexed database 174. In some implementations, the matching of associated content with the target entity 200 may direct the server computing device 170 to the provider resource 180 for access to the associated content. The associated content, including augmented reality content, may be transmitted to the client computing device 102, for display on the display panel 208 of the user interface screen 206.

As described above, in analyzing the image and identifying the target entity 200, the server computing device 170 may recognize, or identify, the boundaries, or periphery, or contour, or shape, or frame of the target entity 200, and may define one or more attachment points 220 that, in turn, may define a frame within which the augmented reality content may be displayed.

As shown in FIG. 4B, in some implementations, an indicator 225 may be displayed on the display panel 208 while the image is transmitted from the client computing device 102 to the server computing device 170, the server computing device 170 performs the recognition and matching as described above, and the augmented reality content is transmitted to the client computing device 102. The indicator 225 may provide a visual indication to the user that the target entity 200 may be an enabled target entity 200 having associated augmented reality content available, and that the recognizing, matching and transmitting processes are being carried out. In the example shown in FIG. 4B, the indicator 225 is a visual indicator, in the form of a bar, for example, a progress bar, progressing along the periphery of the target entity 200.

In the example shown in FIGS. 4A and 4B, the target entity 200 is substantially planar and is defined by a substantially rectangular outer periphery, or contour, or frame. Thus, in this example, the server computing device 170 may identify, or detect, or define, the confines of the target entity 200 by the four exemplary attachment points 220, and the augmented reality content may be transmitted to, or streamed to, the client computing device 102 together with the attachment points 220. This may allow the augmented reality content to be displayed on, or played on, the display panel 208 of the user interface screen 206, with the augmented reality content, remaining connected to the target entity 200 at the attachment points 220, even as the user moves the client computing device 102, as long as the target entity 200 remains in the field of view, or within the viewfinder, of the camera assembly 112 of the client computing device 102.

FIGS. 4C-4G illustrate the sequential display of augmented reality video content transmitted to the client computing device 102 and displayed on the display panel 208 of the user interface screen 206 within the application running on the client computing device 102. In this example, the augmented reality video content 300 includes a virtual representation of a product 350, in the form of a shoe, associated with the recognized, or identified, target entity 200. As shown in FIGS. 4C-4G, in this example, the virtual representation of the product 350 enters the display panel 208, moves to a central portion of the display panel 208, and rotates, so that the user may, for example, view various features of the product 350. FIGS. 4C-4G are static illustrations, intended to represent sequential movement of the product 350 corresponding to an animation.

In some implementations, the user may choose to access additional information, or move further into the experience, during, or after, viewing the presentation of augmented reality content 300. In some implementations, the user may move further into the screen-based experience by, for example, tapping on the target entity, or tapping on a portion of the augmented reality content 300, or interacting with a portion of the user input panel 210. For example, in the exemplary implementation shown in FIG. 41, a tap on a shutter button 211 provided in the user input panel 210, or on the rendered image of the product 350 displayed on the display panel 208, may re-direct the user to an information page 360 including links to product related information, as shown in FIG. 4J.

As noted above, when the target entity 200 is no longer captured within the field of view, or the viewfinder, of the camera assembly 112 of the client computing device 102, the augmented reality experience may be terminated, and real world elements captured within the field of view of the camera assembly 112 of the client computing device 102 may be visible on the display panel 208. As also noted above, the exemplary implementation shown in FIGS. 4A-4J, the user interface screen 206 includes the user input panel 210, displayed together with the display panel 208, for purposes of discussion and illustration. In some implementations, the user interface screen 206 may include both the display panel 208 and the user input panel 210, arranged differently than in this exemplary implementation. In some implementations, the user interface screen 206 may include only the display panel 208. In some implementations, other types of annotations, or supplemental information, may be displayed on the display panel 208.

As noted with respect to the exemplary implementations described above, the augmented reality content displayed on the display panel 208 may be augmented reality video content 300 that is fitted within the contour, or frame, of the target entity 200 based on the identified attachment points 220, as described above. In some implementations, the augmented reality video content may play substantially continuously, and repeat, or loop, until the augmented reality experience is terminated. In some implementations, the augmented reality content 300 may automatically play, without a separate user input initiating playback of the augmented reality content 300. In some implementations, the augmented reality content 300 may automatically loop, without a separate user input selecting re-play of the augmented reality content 300. In some implementations, the augmented reality video content 300 may include audio content that is playable together with the augmented reality video content 300. In some implementations, playback of the associated audio content may be muted, and may be enabled in response to a user selection enabling the playback of the audio content.

In some implementations, the augmented reality content displayed on the display panel 208 may be in graphic interchange format (GIF) that is rendered and displayed within the contour, or frame, of the target entity 200 based on the identified attachment points 220. In some implementations, the augmented reality GIF content may automatically play, without a separate user input initiating playback of the augmented reality GIF content. In some implementations, the augmented reality GIF content may automatically loop, without a separate user input selecting re-play of the augmented reality GIF content.

In some implementations, the augmented reality content displayed on the display panel 208 may be in Hypertext Markup Language (HTML) format that is rendered and displayed within the contour, or frame, of the target entity 200 based on the identified attachment points 220. In some implementations, the augmented reality HTML content may automatically play, without a separate user input initiating playback of the augmented reality HTML content. In some implementations, the augmented reality HTML content may automatically loop, without a separate user input selecting re-play of the augmented reality HTML content.

Exemplary systems and methods as described above may provide users with engaging augmented reality experiences that are closely connected to their immediate environment, and that are easily accessible through, for example, a single application running on the client computing device 102, with relatively minimal user input. These engaging augmented reality experiences may be relatively short, but may, in turn, draw users into longer, more extensive interactions with products, services, and other types of information.

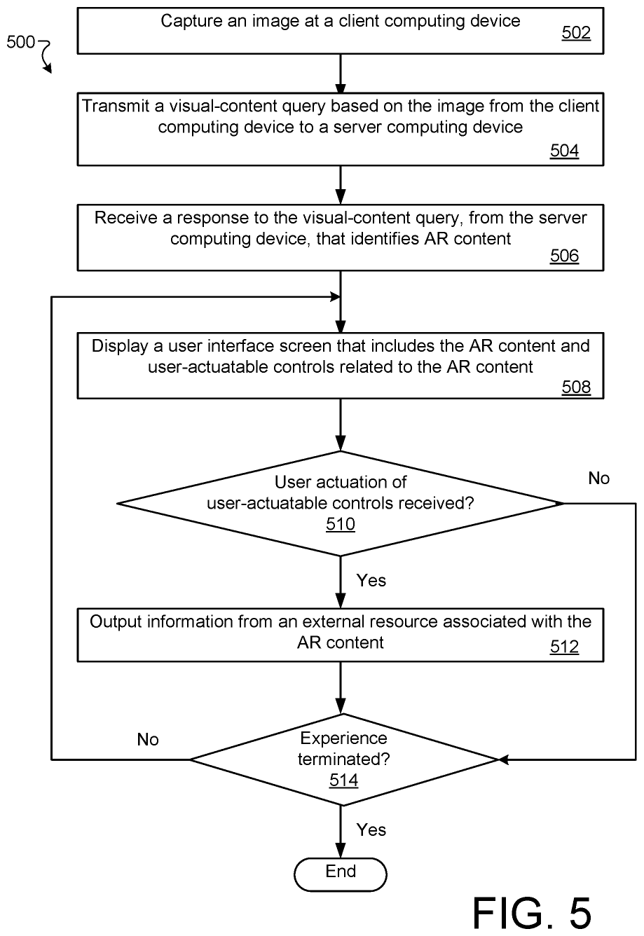

FIG. 5 is a flowchart of an exemplary method 500, to be executed by a client computing device, in accordance with implementations described herein. In some implementations, the exemplary method 500 may be executed within an application running on the client computing device. For ease of description, the exemplary method 500 will be described with respect to the client computing device 102 operating within the exemplary system 100, as discussed above with respect to FIGS. 1 through 4J.

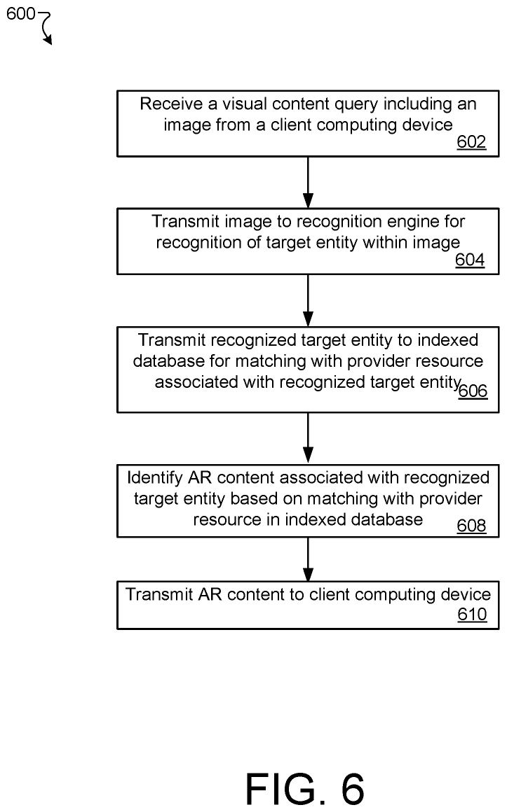

An image may be captured, for example, within a field of view, or a viewfinder, of the camera assembly 112 of the client computing device 102 (block 502). As described above, the image may include a target entity that is of interest to the user. A query, for example, a visual-content query including the image, may be transmitted from the client computing device 102 to the server computing device 170 (block 504), for processing by the server computing device 170 (to be described below with respect to FIG. 6). The client computing device 102 may receive a response to the visual-content query from the server computing device 170. The response may identify augmented reality content that is related to target entity captured within the image included in the visual-content query (block 506). In response to receiving the response including the augmented reality content, the client computing device 102 may display a user interface screen displaying the augmented reality content (block 508). In some implementations, in response to receiving the response to the query, the client computing device 102 may display a user interface screen that also includes user-actuatable controls (block 508). In response to detection of user actuation of one of the user-actuatable controls (block 510), the client computing device 102 may access additional information related to the augmented reality content, and may output the additional information for consumption by the user (block 510). The exemplary method 500 may continue to be executed until it is determined that the experience has been terminated (block 514). Termination of the experience may be detected in response to, for example, detection that the target entity is no longer captured within the field of view, or the viewfinder of the camera assembly 112 of the client computing device 102, a detected user input, and the like.

FIG. 6 is a flowchart of exemplary method 600, to be executed by a server computing device, in accordance with implementations described herein. For ease of description, the exemplary method 600 will be described with respect to the server computing device 170 operating within the exemplary system 100, as discussed above with respect to FIGS. 1 through 4J.

A server computing device 170 may receive a query, for example, a visual-content query, from a client computing device 102 (block 602). The query may include an image, captured within the field of view, or viewfinder, of a camera assembly of the client computing device 102. The image received in the query may include a target entity that is of interest to a user of the client computing device 102. The image included in the query may be processed by a recognition engine 172 of the server computing device 170, to recognize, or identify, the target entity captured in the image included in the query (block 604). An indexed database of the server computing device 170 may be accessed to match the identified, or recognized, target entity with provider resource(s) 180 associated with the identified target entity (block 606). The provider resource(s) may provide access to, for example, augmented reality content related to the target entity, additional information related to the target entity, and the like. The augmented reality content, and the additional information, may be transmitted to the client computing device 102, for output by the client computing device 102 and consumption by the user (block 610).

A system and method, in accordance with implementations described herein, may facilitate access to content, for example, augmented reality content, by simplifying processes for establishing, updating and maintaining links between the indexed database 174 of the server computing device 170 and provider resources 180 that provide access to augmented reality content and associated information related to target entities identified through matching in the indexed database 174.

Exemplary provider resources 180 may include, for example, a museum, a store, a periodical publisher, a restaurant, a transportation provider, educational resources, and countless other resource providers. In general, each of these providers would typically create, maintain, update and service their own, respective individual applications to provide users with content related to their individual products and services. In turn, users would typically have to download, register, and launch the application of a specific provider, to access the content and information specific to that provider. In a system and method, in accordance with implementations described herein, content and information provided by countless different provider resources may be accessed through a single application running on the client computing device 102, eliminating the need for multiple, individual applications specific to individual providers. This display of augmented reality video content as described above may enhance the user experience, and the availability of augmented reality content and related information through a single application (rather than through multiple, separate applications) as described above may simplify the user experience, thus improving user satisfaction.

In one example, a resource provider 180, in the form of, for example, a museum, may wish to have content, for example, augmented reality content, linked in the indexed database 174 of the server computing device 170 of the exemplary system 100 shown in FIG. 1, so that content and information related to the museum is easily accessible to users, through the single application running on the client computing device 102. In some implementations, the content and information may include, for example, augmented reality video content related to exhibits within the museum, in which the exhibits appear to come to life, to pique user interest in the exhibits, and cause the user to delve further into related information also accessible through the single application, which may lead to a visit to the museum. In some implementations, the content and information may include, for example, location of the museum, directions to the museum, parking information, public transportation information, operating hours, admission information, tour information, and the like.

In this example, rather than creating, maintaining, servicing and updating an application specific to the provider (in this example, the museum), a content creator associated with the museum may instead link relevant information to the server computing device 170, for access by users through the single application. In some implementations, to accomplish this, the creator associated with the provider may, for example, create a simple web page that is linked to the indexed database 174 of the server computing device 170. In some implementations, the web page linked to the indexed database 174 may include, for example, a link to a target image, a link to augmented reality content (associated with the target image), and link(s) to additional information if desired. Providers' target images linked in this manner may be matched with images included in the visual-content queries received from client computing devices 102 to recognize, or identify target entities, to locate associated augmented reality content, to locate related information, and the like. In this example, a simple upload of these links to the server computing device 170 in this manner may allow the provider's experience to go live through the single application, without the need for the development of an application specifically for the provider. Similarly, images, content, information and the like may be simply and quickly updated by simply updating the links included in the provider's web page.

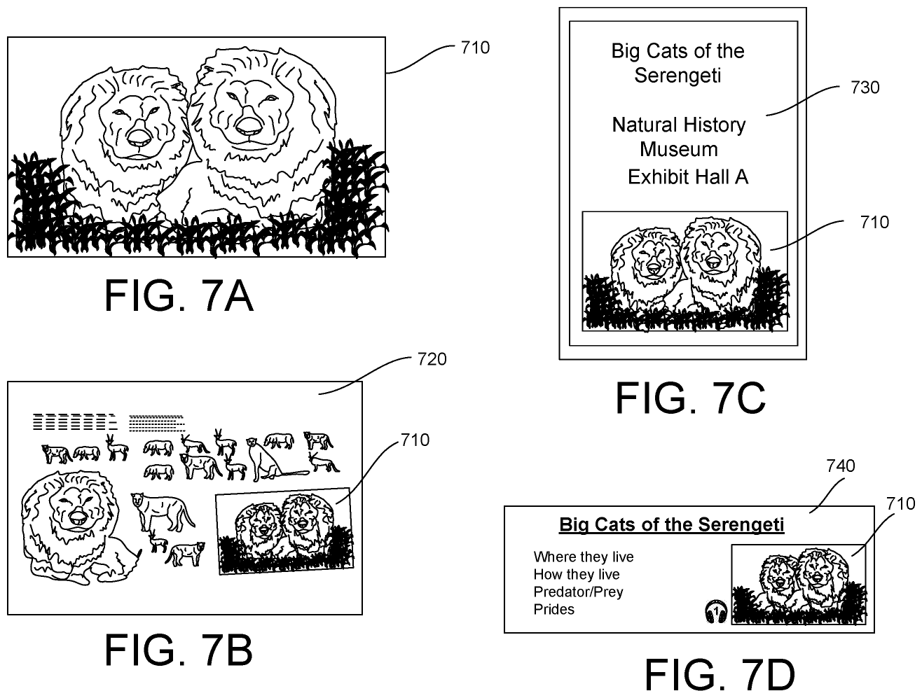

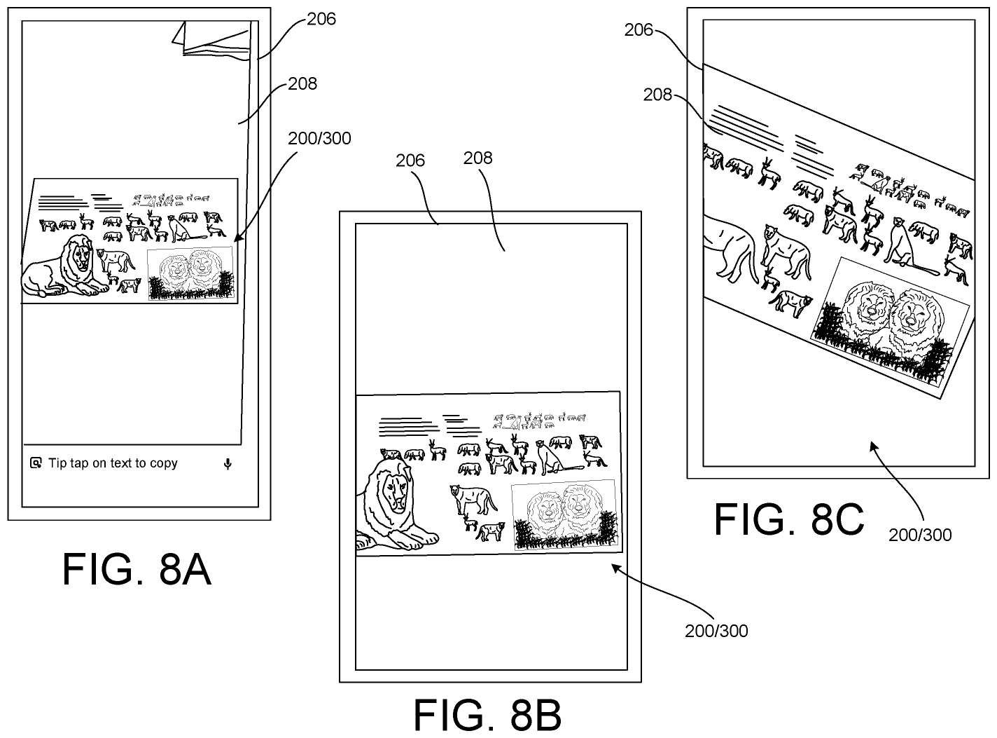

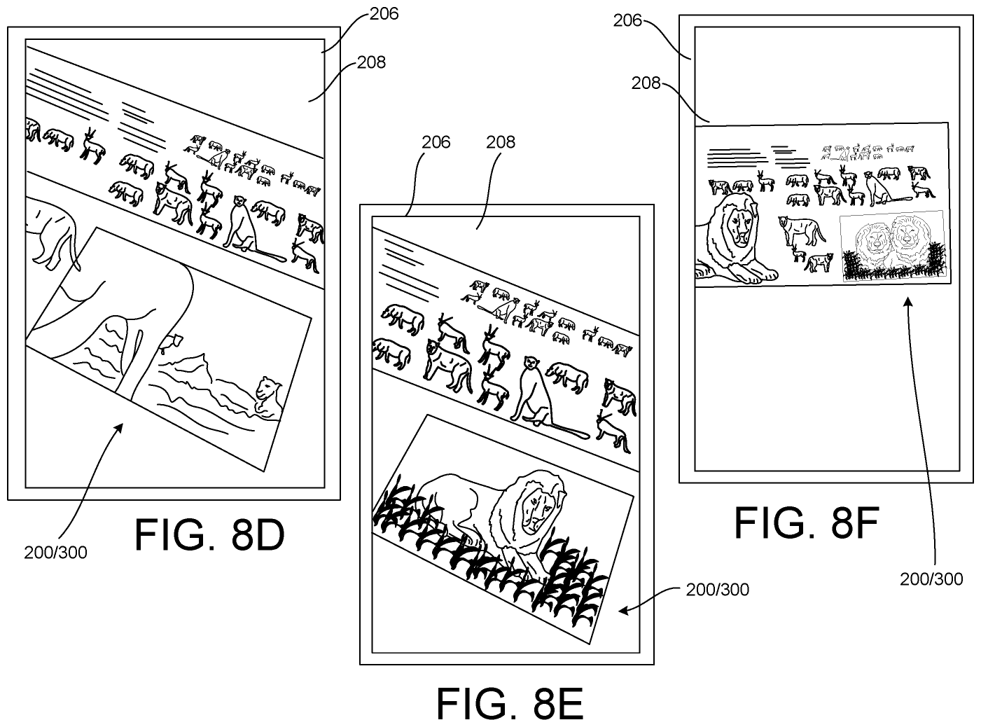

For example, a provider may create a web page, or add a relatively simple markup to an existing website, to link content to the server computing device 170 as described above, so that content, information and the like may be accessible to users through the single application running on the client computing device 102. The creator may designate an image as a target image, and may provide a link to the designated target image in the web page linked to the server computing device 170. The creator may then provide a link to augmented reality content that is associated with the designated target image. An example of this is shown in FIGS. 7A-8G, in which the exemplary provider 180 is a natural history museum.

In this example, the provider 180 (i.e., the museum) may have an exhibit related to Big Cats of the Serengeti. The provider 180 may wish to link content, for example, augmented reality video content, to one or more target entities (for example, images in a brochure, on a poster, and the like) related to this exhibit, so that the entities appear to come alive when encountered by the user, to pique the interest of the user, and draw visitors to the exhibit. As shown in FIG. 7A, a target image 710 may be designated by the provider 180. The target image 710 may be present in one or more locations that are accessible to users having the application available on the client computing device 102. For example, as shown in FIGS. 7B-7D, the target image 710 may be present within a brochure 720 (print or digital) available in various locations outside of the museum, posters 730 displayed in locations outside of the museum, placards 740 displayed within the museum, and the like. The materials including the target image 710 shown in FIGS. 7B-7D are merely exemplary in nature, for purposes of discussion and illustration. The target image 710 may be included in any number of different types of materials which may be encountered by a user, and which would allow the target image to be captured within the field of view of the camera assembly 112 running within the application on the client computing device 102.

As noted above, the creator (associated with the provider 180, i.e., the museum in this example) may provide a link to the designated target image 710 in the simple web page, or linked to the server computing device 170. The creator may also provide a link to augmented reality content that is associated with the designated target image 710, to be stored in the indexed database, and to be used by the indexed database 174 of the server computing device 170 in matching augmented reality content with a recognized target entity. A sample script of an exemplary web page is shown below.

In this manner, a creator may relatively quickly and relatively easily designate a target image 710, and link the target image 710 to augmented reality content, so that the server computing device 170 can recognize the target image 710 within an image received from the client computing device 102, and match the target image 710 to augmented reality content linked in the indexed database 174 for playback on the client computing device without further user intervention.

For example, as shown in FIG. 8A, the brochure 720 may be captured within the field of view, or viewfinder, of the camera assembly 112 running within the application on the client computing device 102. The client computing device 102 may transmit an image frame of the brochure to the server computing device 170, and the recognition engine 172 may match the target entity 200 within the image with the target image 710 linked by the provider 180 as described above. Based on the matching of the target entity 200 detected within the image (of the brochure 720 captured within the viewfinder of the client computing device 102) with the target entity 710 linked by the provider 180, associated augmented reality content 300 may be identified, using the indexed database 174. The augmented reality content 300 may be played on the user interface screen 206 displayed by the client computing device 102, as shown in FIGS. 8B-8F. As described above, in some implementations, the augmented reality content 300 may be transmitted to the client computing device 102 together with designated attachment points, which attach the augmented reality content to the target entity 200 within the viewfinder of the client computing device 102, so that the target entity 200 appears to animate, or to come alive, as the augmented reality content is played.

In this manner, a creator, or developer, may link target images and related content, for example, augmented reality content (on behalf of a resource provider 180), to the server computing device 170 in a relatively simple and relatively quick manner. The linked target images and content may be relatively quickly and easily updated by a simple replacement link within the designated web page. This may allow numerous different resource providers 180 to make content globally accessible via a single application running on the client computing device 102.

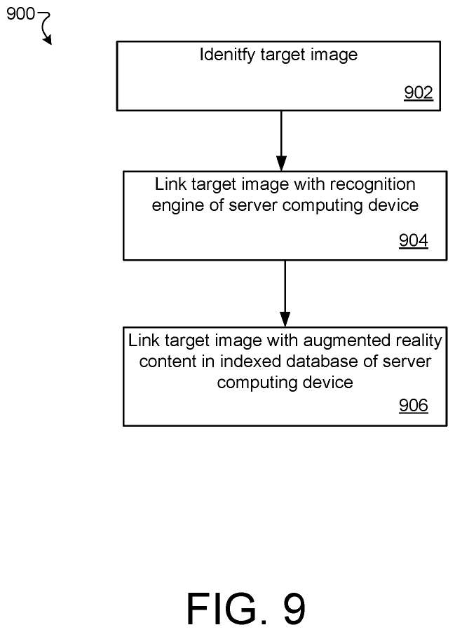

In the corresponding exemplary method shown in FIG. 9, a target image may be identified (block 902), as described above with respect to FIGS. 7A-7D. The target image may be linked with a recognition engine of a server computing device (block 904), for recognition, or identification, of a target entity within an image frame provided by a client computing device 102. The target image may also be linked to content, for example, augmented reality content, through an indexed database of the server computing device (block 906). Upon identification, or recognition of the target entity, the augmented reality content may be retrieved via the indexed database and transmitted to the client computing device.

In a system and method as described above, in accordance with implementations described herein, augmented reality content may replace, for example, virtually replace, a corresponding target entity. In the particular example implementation described above, the system and method, in accordance with implementations described herein, may allow for two-dimensional (2D) augmented reality content to virtually replace 2D planar target images, to, for example, create the appearance of animation of the 2D planar target image, such that the planar target image appears to come alive. Augmented reality content may be applied in this manner to any enabled target entity, i.e., any target entity for which matching in the indexed database of the server computing device and access to associated augmented reality content (for example, from the provider resource) is available. The system and method, in accordance with implementations described herein, may be implemented within a single application running on a client computing device. This single application may facilitate the provision of augmented reality content in this manner, for any number of different entities, rather than the multiple, independent applications otherwise required for each of the different entities.

In some implementations, the augmented reality content in the form of video content may be considered an end product for consumption by the user. For example, augmented reality content in the form of a movie trailer, provided in response to a visual content query including a movie poster (with the movie poster/movie being the target entity), may be the end product desired by the user. In some implementations, the user may seek additional information associated with the movie (i.e., the target entity), such as, for example, reviews, show times, locations, pricing, ticket purchase options, and the like. Whether the augmented reality video content is the end product desired by the user, or simply an immersive tool to draw the user into the main content, a system and method, in accordance with implementations described herein, may provide a simple

The various exemplary implementations described above are provided simply for ease of discussion and illustration. A system and method, in accordance with implementations described herein, may be usable to any number of different types of applications, such as, for example, living periodicals (i.e., books, magazines, newspapers and the like), living product packaging, living advertising, living shopping, living entertainment (i.e., movies, artwork, touring, gaming, navigation and the like), living educational materials, living correspondence, and numerous other such enterprises.

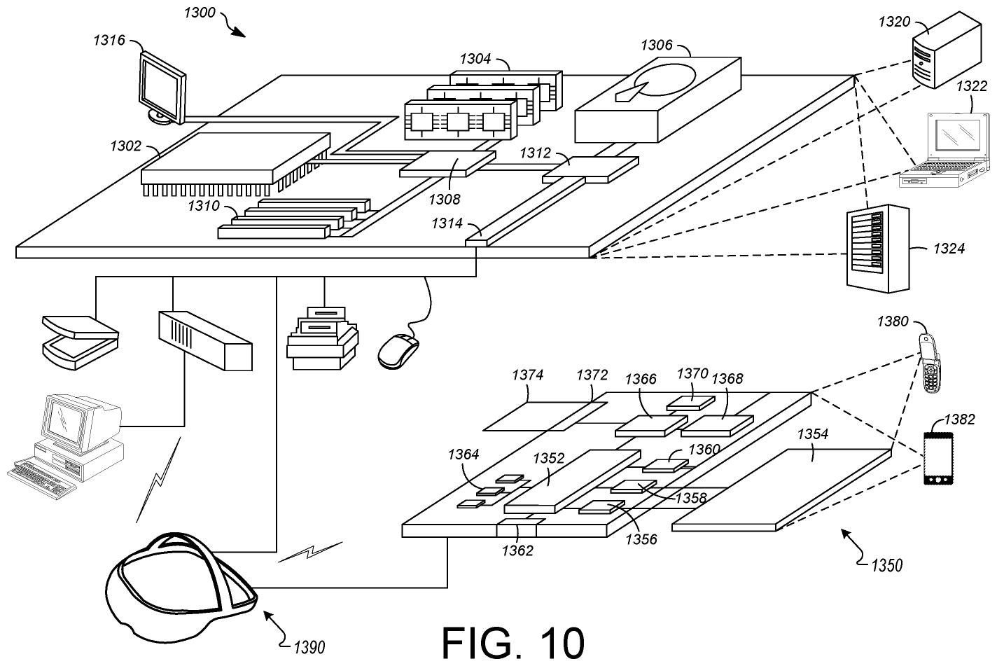

FIG. 10 shows an example of a computer device 1300 and a mobile computer device 1350, which may be used with the techniques described here (e.g., to implement the client computing device 102, the server computing device 170, and the provider resources 180). The computing device 1300 includes a processor 1302, memory 1304, a storage device 1306, a high-speed interface 1308 connecting to memory 1304 and high-speed expansion ports 1310, and a low-speed interface 1312 connecting to low-speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high-speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high-speed controller 1308 manages bandwidth-intensive operations for the computing device 1300, while the low-speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display), and LED (Light Emitting Diode) or an OLED (Organic Light Emitting Diode) display, or other appropriate display technology. The display interface 1356 may include appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In-Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, Wi-Fi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smartphone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 13 can include sensors that interface with an AR headset/HMD device 1390 to generate an augmented environment for viewing inserted content within the physical space. For example, one or more sensors included on a computing device 1350 or other computing device depicted in FIG. 13, can provide input to the AR headset 1390 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 1350 can use the sensors to determine an absolute position and/or a detected rotation of the computing device in the AR space that can then be used as input to the AR space. For example, the computing device 1350 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 1350 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1350 when the computing device is incorporated into the AR space can cause a particular action to occur in the AR space.

In some implementations, a touchscreen of the computing device 1350 can be rendered as a touchpad in AR space. A user can interact with the touchscreen of the computing device 1350. The interactions are rendered, in AR headset 1390 for example, as movements on the rendered touchpad in the AR space. The rendered movements can control virtual objects in the AR space.

In some implementations, one or more output devices included on the computing device 1350 can provide output and/or feedback to a user of the AR headset 1390 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 1350 may appear as another object in a computer-generated, 3D environment. Interactions by the user with the computing device 1350 (e.g., rotating, shaking, touching a touchscreen, swiping a finger across a touch screen) can be interpreted as interactions with the object in the AR space. In the example of the laser pointer in an AR space, the computing device 1350 appears as a virtual laser pointer in the computer-generated, 3D environment. As the user manipulates the computing device 1350, the user in the AR space sees movement of the laser pointer. The user receives feedback from interactions with the computing device 1350 in the AR environment on the computing device 1350 or on the AR headset 1390. The user's interactions with the computing device may be translated to interactions with a user interface generated in the AR environment for a controllable device.

In some implementations, a computing device 1350 may include a touchscreen. For example, a user can interact with the touchscreen to interact with a user interface for a controllable device. For example, the touchscreen may include user interface elements such as sliders that can control properties of the controllable device.

Computing device 1300 is intended to represent various forms of digital computers and devices, including, but not limited to laptops, desktops, workstations, personal digital assistants, servers, blade servers, mainframes, and other appropriate computers. Computing device 1350 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer-implemented method, comprising:
capturing an image within a live viewfinder of a client computing device;
transmitting, by the client computing device, a query to a server computing device, the query including the image;
receiving, by the client computing device, a response to the query from the server computing device, the response including augmented reality content; and
triggering display of a user interface screen on the client computing device, the user interface screen including the augmented reality content displayed within a contour defined by coordinates included in the response received from the server computing device.

2. The computer-implemented method of claim 1, wherein the image includes a target entity captured within a field of view of the live viewfinder of the client computing device, and wherein receiving the response to the query includes receiving augmented reality video content associated with the target entity included in the image.

3. The computer-implemented method of claim 2, wherein receiving the response to the query from the server computing device includes:
receiving the coordinates defining the contour for the display of the augmented reality video content on the user interface screen, the contour corresponding to a periphery of the target entity.

4. The computer-implemented method of claim 3, wherein triggering display of the user interface screen includes:
displaying the user interface screen within the live viewfinder of the client computing device; and
attaching the display of the augmented reality video content to the target entity at attachment points corresponding to the coordinates, such that the display of the augmented reality video content remains attached to the target entity within the live viewfinder of the client computing device.

5. The computer-implemented method of claim 4, further comprising:
detecting a first movement of the client computing device;
shifting a display of the target entity within the live viewfinder of the client computing device in response to the detected first movement; and
shifting a display of the augmented reality video content to correspond to the shifted display position of the target entity within the live viewfinder of the client computing device.

6. The computer-implemented method of claim 5, wherein
detecting the first movement includes detecting at least one of a change in a position, an orientation, or a distance between the live viewfinder of the client computing device and the target entity; and
shifting the display of the augmented reality video content includes changing at least one of a display position, a display orientation, or a display size of the augmented reality video content to respectively correspond to the changed display position, orientation or distance of the target entity.

7. The computer-implemented method of claim 5, further comprising:
detecting a second movement of the client computing device such that the target entity is not captured within the live viewfinder of the client computing device; and
terminating the display of the augmented reality video content in response to the detected second movement.

8. The computer-implemented method of claim 7, wherein triggering display of the user interface screen includes looping the augmented reality content until the second movement is detected, or until a termination input is received.

9. The computer-implemented method of claim 2,
triggering display of the user interface screen includes triggering display of a display panel and a user input panel; and
receiving the response to the query includes:
receiving the augmented reality video content for display on the display panel of the user interface screen; and
receiving auxiliary information related to the target entity for display on the user input panel of the user interface screen.

10. The computer-implemented method of claim 1, wherein the capturing the image within the live viewfinder of the client computing device, the transmitting, the receiving, and the triggering are done within an application running on the client computing device.

11. A computer-implemented method, comprising:
receiving, by a server computing device, a query from a client computing device, the query including an image;
detecting, by a recognition engine of the server computing device, a target entity within the image included in the query;
matching, in an indexed database of the server computing device, the target entity with augmented reality content from an external provider; and
transmitting, to the client computing device, the augmented reality content for output by the client computing device.

12. The computer-implemented method of claim 11, where receiving the query including the image includes receiving the query including the image in which the target entity is captured within a live viewfinder of the client computing device.

13. The computer-implemented method of claim 11, wherein detecting the target entity within the image included in the query includes identifying the target entity based on a target image linked with the recognition engine by the external provider.

14. The computer-implemented method of claim 13, wherein matching the target entity with the augmented reality content includes matching the target entity with content, linked in the indexed database with the target image by the external provider.

15. The computer-implemented method of claim 11, wherein detecting the target entity includes:
detecting a peripheral contour of the target entity within the image; and
defining attachment points along the detected peripheral contour so as to define the peripheral contour of the target entity.

16. The computer-implemented method of claim 15, wherein transmitting the augmented reality content for output by the client computing device includes:
transmitting the attachment points to the client computing device together with the augmented reality content, for output of the augmented reality content by the client computing device within the contour defined by the attachment points.

17. A computer-readable storage medium storing instructions which, when executed by one or more processors, cause the one or more processors to perform the computer-implemented method of claim 11.

18. A client computing device, comprising a live viewfinder, one or more processors, and a memory storing instructions which, when executed by the one or more processors, cause the one or more processors to perform the computer-implemented method of claim 1.

19. A server computing device, comprising a recognition engine, an indexed database, one or more processors, and a memory storing instructions which, when executed by the one or more processors, cause the one or more processors to perform the computer-implemented method of claim 11.

20. A system, comprising the client computing device of claim 18, and the server computing device of claim 19.
